(19) United States
(12) Patent Application Publication
(10) Pub. No.: US 2025/0244163 A1
(43) Pub. Date: Jul. 31, 2025

(54) WEIGHBRIDGE

(71) Applicant: Illinois Tool Works Inc., Glenview, IL (US)

(72) Inventors: Graham James HOLLAND, Dereham (GB); Bradley Lawrence Jack GILLOTT, Rotherham (GB); Peter Vincent RITCHIE, Wolverhampton (GB); Philip Andrew TOMLINSON, Northwich (GB); Neil Fred WETHERALL, Wolverhampton (GB); Paul Joseph COOPER, Devizes (GB)

(21) Appl. No.: 19/041,669

(22) Filed: Jan. 30, 2025

(30) Foreign Application Priority Data
Jan. 31, 2024 (GB) 2401295.7

(51) Int. Cl. G01G 19/02; G01G 21/22; G01G 21/23

(52) U.S. Cl. CPC G01G 19/02; G01G 21/22; G01G 21/23

(57) ABSTRACT

This invention relates to a weighbridge (10) having a deck (20) and a bridging portion (50). The deck has first (22) and second ends (24) the bridging portion (50) has a first end (50a) attached to an end (22) of the deck (20) and a free end at second end (50b). The bridging portion (50) is configured to provide a bridge between the end (22) of the deck (22) and a static substrate, in use.

### TECHNICAL FIELD

This disclosure relates generally to a weighbridge. More specifically, this disclosure relates to a weighbridge having a means to compensate for the difference in level between a deck of the weighbridge and a surrounding static substrate, e.g. the ground. The disclosure further relates to a bridging portion for a weighbridge, a kit of parts and to a method of installing a weighbridge.

### BACKGROUND

Weighbridges, otherwise known as truck scales or railroad scales, are scales used to weigh rail or road vehicles and their contents. This can help ensure vehicles comply with the law whilst transporting goods and/or can allow companies to determine the weight of the contents of vehicles to ensure that customers are charged correctly. Weighbridges are often permanent installations, mounted on a concrete foundation and may be recessed relative to the surrounding substrate (a so called “pit-mounted” weighbridge) or may be positioned above the surrounding substrate (a so called “above-ground” weighbridge).

When a new weighbridge is to be installed at a site, it is often the case that the site is already provided with a concrete slab or pit and/or one or more ramps. This may be due to preparatory groundworks having already taken place, or the new weighbridge is being installed to replace a pre-existing one. However, because of this it has been found that when installing a new weighbridge, the level of the deck is often inconsistent with the surrounding site. Furthermore, the load points of the existing concrete slab or pit may not match-up with the load points on the new weighbridge. As a result, extensive additional groundworks may be required at the site to facilitate the installation of the new weighbridge.

It is therefore a first non-exclusive object of the disclosure to provide a weighbridge having a bridging element that overcomes one or more disadvantages of known weighbridges.

### SUMMARY

Accordingly, an aspect of the disclosure provides weighbridge comprising: a deck having first and second ends; and a bridging portion having a first end attached to an end of the deck and free end at a second end, wherein the bridging portion is configured to provide a bridge between the end of the deck and a static substrate, in use.

The deck may extend between the first and second ends.

The deck may be generally planar.

The deck may comprise a driving surface. The driving surface may be generally planar.

The first and second ends of the deck may be respective first and second terminal ends of the deck.

At least one of the first and second ends of the deck may comprise an end box.

Each of the first and second ends of the deck may comprise an end box.

The end box may be arranged to house or receive a measuring device, e.g. a load cell, Weigh Bar®, weight bar or shear pin.

The bridging portion may extend from and/or beyond an end or a terminal end of the deck.

The bridging portion may extend from and/or beyond a load point of the weighbridge or the deck.

Each end box may provide a load point of the weighbridge or the deck.

The bridging portion may provide an extension to the deck and/or an extension to the driving surface of the deck.

The bridging portion may be attached to an end box.

The bridging portion may be removably attached to the deck or end box.

The bridging portion may be welded to the deck or end box.

The bridging portion may be bolted or fastened to the deck or end box.

The bridging portion may be attached, e.g. welded, to an end wall of the deck.

The or each end box may comprise an end wall.

The end wall of the end box may be or may provide the first end of the bridging portion.

The bridging portion may extend from an end of the deck in a cantilever arrangement.

The bridging portion may be or may describe a cantilever.

The bridging portion may define a braced cantilever arrangement.

The bridging portion may be or may describe a braced cantilever.

The bridging portion may be generally wedge-shaped.

The bridging portion may be or may comprise a wedge.

The bridging portion may taper towards or in the direction of the second end.

The bridging portion may narrow towards the second end.

The bridging portion may comprise a mounting plate or a mounting flange at the first end attached to the end or end box of the deck.

The bridging portion may comprise a driving surface.

The driving surface may extend from the mounting plate to the second end.

A first end of the driving surface of the bridging portion may be positioned at an end of the driving surface of the deck.

A second end of the driving surface of the bridging portion may be at the second end.

The bridging portion may comprise a web connected to the driving surface.

It will be appreciated that the web may alternatively be referred to as a bracket or stiffening member hereinafter.

The bridging portion may comprise a web connected between an end of the deck, an end wall of the deck or an end box, and the driving surface.

The bridging portion may comprise a web connected between the mounting plate and the driving surface.

The bridging portion may comprise a web connected to each of the mounting plate and the driving surface.

The bridging portion may comprise a web connected to each of an end of the deck, an end wall of the deck or an end box, and the driving surface.

The bridging portion may comprise a plurality of webs.

Each of the plurality of webs may be connected to the driving surface.

Each of the plurality of webs may be connected between the mounting plate and the driving surface.

Each of the plurality of webs may be connected to each of the mounting plate and the driving surface.

Each of the plurality of webs may be connected between an end of the deck, an end wall of the deck or an end box, and the driving surface.

Each of the plurality of webs may be connected to each of an end of the deck, an end wall of the deck or an end box, and the driving surface.

The plurality of webs may be spaced, e.g. equally, along a width of the bridging portion.

It will be understood that a widthwise direction in respect of the bridging portion is a direction generally transverse to a general direction in which a vehicle will travel over or traverse the bridging portion.

The web may be a stiffening web.

The or each web may generally wedge-shaped or triangular.

The bridging portion may be attached to the deck via the webs, or via one or more webs, e.g. by welding.

The bridging portion may inclined relative to the deck, e.g. the driving surface of the deck.

The driving surface of the bridging portion may be inclined relative to the deck, e.g. the driving surface of the deck.

The bridging portion may be spaced from a static substrate, e.g. the ground, in use.

The bridging portion may be out of contact with a static substrate, e.g. the ground, in use.

The bridging portion may comprise an access cover for allowing access to a space below the bridging portion, in use.

The access cover may be provided in the driving surface of the bridging portion.

The weighbridge may be modular.

The weighbridge may comprise a static substrate. The static substrate may comprise a ramp.

The bridging portion may provide a bridge between an end of the deck and the ramp, e.g. in use.

The bridging portion may extend from end of the deck towards the or a ramp.

The bridging portion may extend from end of the deck towards the or a static substrate.

The static substrate may be or may comprise the ground or a foundation of the weighbridge.

The weighbridge may be or may comprise a pit weighbridge.

The weighbridge may be located within a pit.

The bridging portion may bridge across a part of the pit between an end of the deck and the static substrate located externally of the pit, e.g. in use.

The weighbridge may be or may comprise a surface mounted weighbridge.

The weighbridge may be mounted on ground supports.

Each of the first and second end or end box may be mounted on respective ground support.

The bridging portion may be adjustable.

The bridging portion may be adjustable relative to the deck.

The inclination of the bridging portion relative to the deck may be adjustable.

The inclination of the driving surface of the bridging portion relative to the driving surface of the deck may be adjustable.

The bridging portion may be hingedly attached to an end of the deck or an end box of the deck.

A free end of the bridging portion may contact the static substrate.

Another aspect of the disclosure provides a bridging portion for providing a bridge between an end of a weighbridge deck and a static substrate, the bridging portion having a first end for attachment to an end of a weighbridge deck, a driving surface extending from the first end to a free end at a second end and one or more webs connected to the driving surface.

The bridging portion may comprise a mounting element at the first end for attachment to the end or an end box of a deck.

The mounting element may comprise a mounting plate or a mounting flange.

The mounting element may comprise an edge or a portion of one or more of the webs.

One or more webs may be connected to the driving surface, e.g. by welding.

One or more webs may be connected between the mounting plate or mounting flange and the driving surface.

One or more webs may be connected to each of the mounting plate or mounting flange and the driving surface.

The bridging portion may comprise a wedge.

The bridging portion may be generally wedge-shaped.

Another aspect of the disclosure provides a kit of parts comprising a weighbridge deck and a bridging portion as described above.

Another aspect of the disclosure provides a method of installing a weighbridge, the method comprising: providing a weighbridge deck having first and second ends; providing a bridging portion having a first end for attachment to an end of the deck, and a free end at a second end; attaching the first end of the bridging portion to an end of the deck; positioning the weighbridge at a site such that the bridging portion provides a bridge between the end of the deck and a static substrate.

The method may comprise first determining relative levels of the weighbridge deck and surrounding static substrate at the site.

The method may comprise attaching the bridging portion to the deck to compensate for the relative levels.

Compensating for the relative levels may comprise attaching the bridging portion such that it is inclined relative to the deck.

The method may comprise installing the weighbridge such that the second end of the bridging portion is out of contact with a static substrate.

For the avoidance of doubt, any of the features described herein apply equally to any aspect of the disclosure. For example, the bridging portion, kit of parts or method may comprise any one or more features of the weighbridge relevant to the bridging portion, kit of parts or method and/or the method may comprise any one or more features or steps relevant to one or more features of the weighbridge, bridging portion or kit of parts.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the disclosure, whether or not these are expressly claimed. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF SEVERAL VIEWS OF THE DRAWINGS

Embodiments of the disclosure will now be described by way of example only with reference to the accompanying drawings in which:

FIG. 1 is an upper perspective view of a weighbridge including a bridging portion in accordance with an aspect of the disclosure;

FIG. 2 is a lower perspective view of the weighbridge of FIG. 1;

FIG. 3 is a detail view of the connection between the weighbridge and bridging portion of FIG. 1;

FIG. 4 is an upper perspective view of the bridging portion of FIG. 1;

FIG. 5 is a lower perspective view of the bridging portion of FIG. 4;

FIG. 6 is a side view of the bridging portion of FIG. 4; and

FIG. 7 is a detail view of an underside of the bridging portion of FIG. 4 with some webs removed.

### DETAILED DESCRIPTION

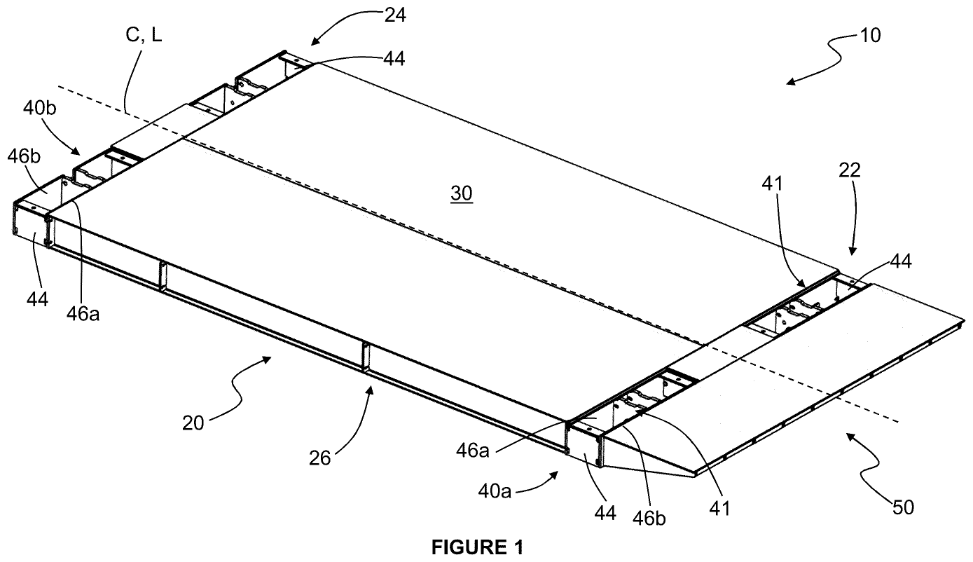

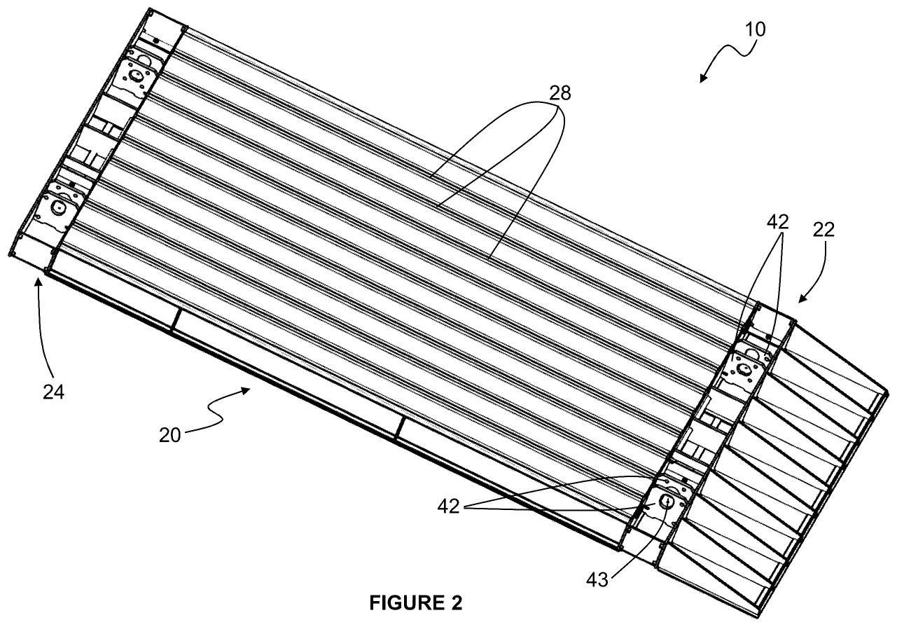

Referring now to FIGS. 1 and 2, there is shown a weighbridge 10, which is a modular weighbridge in this embodiment, having a deck 20 configured to support a vehicle. A bridging portion 50 is attached to an end of the deck 20 and is configured to provide a bridge between the end of the deck 20 and a static substrate, e.g. the ground (not shown), in use.

The deck 20 is generally rectangular when viewed in plan and extends along a longitudinal axis L between first and second ends 22, 24, which are terminal ends of the deck in this embodiment. The weighbridge 10 is also symmetrical about a central axis C which is parallel to the longitudinal axis L. The deck 20 includes a substructure 26 comprising a plurality of lengthwise extending supporting beams 28 which are in the form of I-beams. The supporting beams 28 are equally spaced along a width of the deck 20. In use, a lower side of each of the supporting beams 28, shown in FIG. 2, contacts a static substrate, e.g. the ground, a concrete foundation or a concrete pad at a weighbridge site (not shown).

A planar driving surface 30 (hereinafter “driving surface 30”) is provided on an upper side of the supporting beams 28 and is configured to support a vehicle such that a vehicle weighing operation can be carried out. The driving surface 30 is provided by two identical rectangular sheets in this embodiment.

A first end box 40a is provided at the first end 22, and a second end box 40b is provided at the second end 24. It will be appreciated that the first and second end boxes 40a, 40b are identical in this embodiment, but in some embodiments they may be different. Each end box 40a, 40b is arranged to provide a load point for the weighbridge 10, in use.

Furthermore, each end box 40a, 40b, defines a widthwise extending receptacle arranged to house or receive a measuring device, e.g. a load cell, Weigh Bar®, weight bar or shear pin (hereinafter ‘shear pin’, not shown).

More specifically, each receptacle is shown having two identical spaced compartments 41 located either side of the central axis C of the deck 20. Although not shown in FIGS. 1 and 2, it will be appreciated that in use, each compartment 41 would include a respective access cover providing a continuation of the driving surface 30. Each compartment 41 also includes a pair of shear pin guides 42, as shown more clearly in FIG. 2 in particular. The shear pin guides 42 each include a respective aperture 43 for receipt of a widthwise extending shear pin, in use.

Each end box 40a, 40b is defined by a pair of widthwise spaced end plates 44 interconnecting a pair of longitudinally spaced end walls, including an innermost end wall 46a and an outermost end wall 46b.

In this embodiment, the bridging portion 50 is attached to the first end 22 of the deck 20, and more specifically to the first end box 40a. In particular, the bridging portion 50 is welded to the outermost end wall 46b of the first end box 40a.

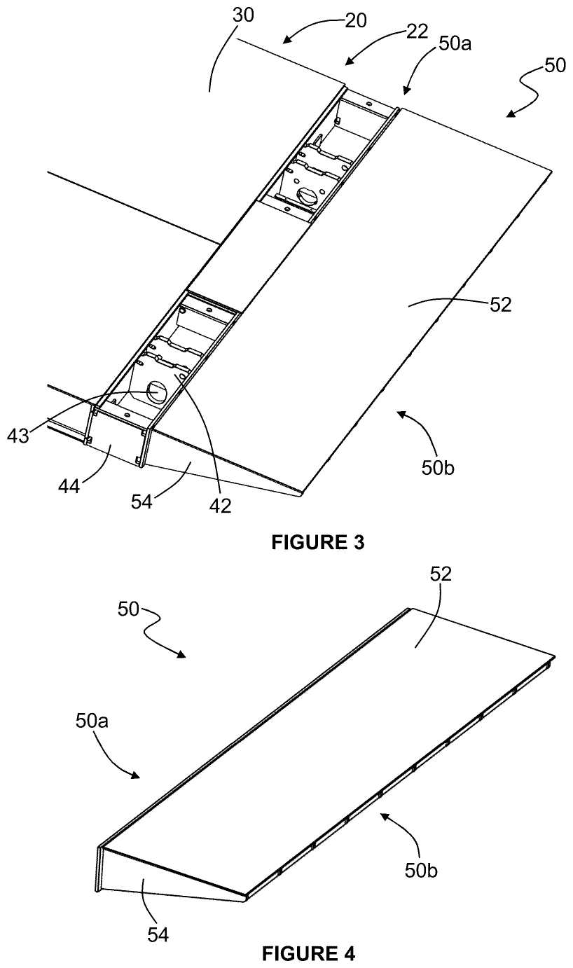

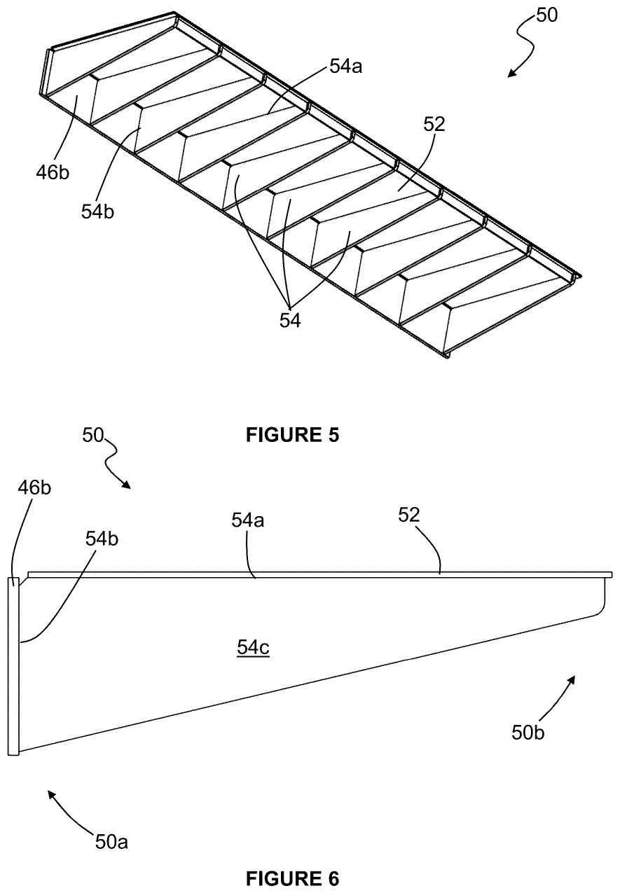

Referring now to FIGS. 3 to 7, there is shown the bridging portion 50 in greater detail. The bridging portion 50 is generally wedge-shaped, having a generally triangular profile when viewed in a direction transverse to the longitudinal axis L, as shown in FIG. 6 in particular. More specifically, the bridging portion 50 has a first end 50a attached to the deck 20 and a free end at a second end 50b arranged along the longitudinal axis L from the first end 50a, and wherein the bridging portion 50 tapers towards the second end 50b.

The bridging portion 50 defines a braced cantilever arrangement and includes a planar driving surface 52 (hereinafter “driving surface 52”) and a plurality of longitudinally extending webs 54. In the arrangement described herein, the driving surface 52 of the bridging portion 50 is coplanar with the driving surface 30 of the deck 20, but it will be appreciated that the bridging portion 50 may be attached to the deck 20 such that the driving surface 52 is inclined with respect to the driving surface 30.

The webs 54 extend generally parallel to the longitudinal axis L, are generally triangular and have a first edge 54a attached to an underside of the driving surface 52. The webs 54 are equally spaced along the width of the bridging portion 50 and are attached to the underside of the driving surface 52 by welding. It will be appreciated that the webs 54 may be attached to the underside of the driving surface 52 by other suitable means, for example one or more brackets or adhesive.

The bridging portion 50 is attached to the deck 20 via the webs 54. More specifically, a second edge 54b of each of the webs 54 is attached to an outermost end wall 46b of the first end box 40a by welding. However, it will be appreciated that the bridging portion may instead include a mounting plate to which the webs are attached, and wherein said mounting plate may be attached to the deck by welding or by using one or more fixings. The webs 54 may be attached to the mounting plate by any suitable means, for example welding, one or more brackets or adhesive.

The bridging portion 50 extends from the first end 22 of the deck 20 and is spaced from a static substrate, e.g. the ground, in use.

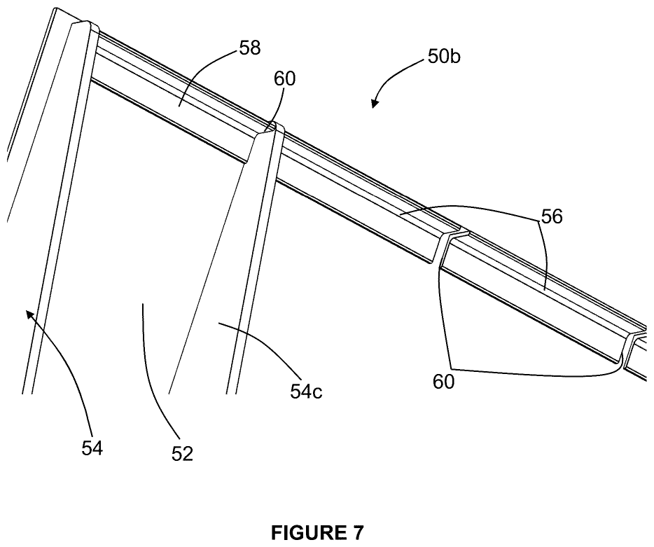

As is shown in FIG. 7 in particular, the bridging portion 50 is provided with a plurality of stiffening elements 56 located between the webs 54 proximate the second end 50b. The stiffening elements 56 are in the form of right angled brackets in this embodiment, having a first surface 58 attached to an underside of the driving surface 52 and a pair of widthwise end surfaces 60 each attached to a planar side surface 54c of a respective web 54.

It will be appreciated by those skilled in the art that several variations to the aforementioned embodiments are envisaged without departing from the scope of the disclosure.

It will also be appreciated by those skilled in the art that any number of combinations of the aforementioned features and/or those shown in the appended drawings provide clear advantages over the prior art and are therefore within the scope of the disclosure described herein.

What is claimed is:

1. A weighbridge, comprising:
a deck configured to support a vehicle;
a bridging portion is attached to an end of the deck and configured to provide a bridge between the end of the deck and a static substrate.

2. The weighbridge as defined in claim 1, wherein:
the deck is generally rectangular when viewed in plan and extends along a longitudinal axis L between first and second ends, which are terminal ends of the deck;
the weighbridge is symmetrical about a central axis C which is parallel to the longitudinal axis L;
the deck includes a substructure comprising a plurality of lengthwise extending supporting beams, the supporting beams being equally spaced along a width of the deck; and
in use, a lower side of each of the supporting beams contacts a static substrate.

3. The weighbridge as defined in claim 2, further comprising a planar driving surface is provided on an upper side of the supporting beams and is configured to support a vehicle such that a vehicle weighing operation can be carried out.

4. The weighbridge as defined in claim 2, further comprising a first end box at the first end, and a second end box at the second end, each of the end boxes being arranged to provide a load point for the weighbridge.

5. The weighbridge as defined in claim 4, wherein each end box defines a widthwise extending receptacle arranged to house or receive a measuring device.

6. The weighbridge as defined in claim 5, wherein each receptacle comprises two identical spaced compartments located on either side of the central axis C of the deck, each compartment having a respective access cover providing a continuation of the driving surface, and. each compartment comprising a pair of shear pin guides, each of the shear pin guides having a respective aperture configured to receive a widthwise extending shear pin.

7. The weighbridge as defined in claim 4, wherein each end box is defined by a pair of widthwise spaced end plates interconnecting a pair of longitudinally spaced end walls, including an innermost end wall and an outermost end wall.

8. The weighbridge as defined in claim 7, wherein the bridging portion is attached to the first end of the deck.

9. The weighbridge as defined in claim 1, wherein the bridging portion is generally wedge-shaped, having a generally triangular profile when viewed in a direction transverse to the longitudinal axis L, the bridging portion comprising a first end attached to the deck and a free end at a second end arranged along the longitudinal axis L from the first end, and wherein the bridging portion tapers towards the second end.

10. The weighbridge as defined in claim 1, wherein the bridging portion defines a braced cantilever arrangement and includes a planar driving surface and a plurality of longitudinally extending webs, the driving surface of the bridging portion being coplanar with the driving surface of the deck.

11. The weighbridge as defined in claim 10, wherein the webs extend generally parallel to the longitudinal axis L, are generally triangular and have a first edge attached to an underside of the driving surface, the webs being equally spaced along the width of the bridging portion and attached to the underside of the driving surface.

12. The weighbridge as defined in claim 10, wherein the bridging portion is attached to the deck via the webs, a second edge of each of the webs being attached to an outermost end wall of the first end box.

13. The weighbridge as defined in claim 1, wherein the bridging portion extends from the first end of the deck and is spaced from a static substrate.

14. The weighbridge as defined in claim 10, the bridging portion comprises a plurality of stiffening elements located between the webs proximate the second end, the stiffening elements comprising right-angled brackets having a first surface attached to an underside of the driving surface and a pair of widthwise end surfaces each attached to a planar side surface of a respective web.
